(19) United States
(12) Patent Application Publication
(10) Pub. No.: US 2004/0047953 A1
(43) Pub. Date: Mar. 11, 2004

(54) Baking wipes

(76) Inventor: Jacqueline Lauby, Roswell, GA (US)

Correspondence Address: THOMAS, KAYDEN, HORSTEMEYER & RISLEY, LLP, Suite 1750, 100 Galleria Parkway N.W., Atlanta, GA, 30339-5948, US

(21) Appl. No.: 10/236,736

(22) Filed: Sep. 5, 2002

(51) Int. Cl. A23G 1/00

(52) U.S. Cl. 426/132

(57) ABSTRACT

A baking wipe includes a folded substrate having a first portion and a second portion, wherein a first surface of the first portion faces a second surface of the second portion, and a layer of shortening that is located between the first portion and the second portion, and that is in contact with the first surface and with the second surface, wherein the layer of shortening has a substantially uniform thickness.

### FIELD OF THE INVENTION

The present invention generally relates to baking. More specifically, the present invention relates to systems and methods for applying shortening to baking vessels.

### DESCRIPTION OF THE RELATED ART

Packaging comprising commercially produced mixes for making cakes, brownies, and breads frequently direct consumers to grease a baking vessel with shortening: a Pillsbury cake mix packaging states “Grease pan generously with shortening”; a Duncan Hines cake mix packaging states “Grease sides and bottom of each pan with shortening”; a Duncan Hines brownie mix packaging states “Grease bottom of pan with shortening”. Moreover, many recipes in cooking/baking publications (e.g., Cooking and Gourmet) recommend pre-coating bake-ware with shortening in order to achieve optimum results in food prepared by baking. Conventional application of shortening traditionally involves several steps of obtaining a substrate (usually wax paper or paper towel), obtaining a container of shortening from a storage location, opening the container, dipping the substrate into the container, using the substrate to wipe shortening onto a baking vessel (e.g., a baking pan), disposing of the substrate, closing the container, and returning the container to its storage location. Such approach however, can be time consuming and messy.

Prior art systems and methods for lubricating baking vessels include U.S. Pat. No. 2,796,363 (Coating Cooking Vessels and Method of Coating) and U.S. Pat. No. 4,023,912 (Solid Stick Pan Lubricant). Such prior art systems and methods, however, fail to deliver optimum baking results. Using the aerosol system disclosed in U.S. Pat. No. 2,796,363, for example, can deliver an erratic and uneven lubricating film which is often too thin and which often fails to provide desirable or optimum results in baked food. The high level of liquefied oil necessary to effect aerosol propulsion has the additional disadvantage of being absorbed by the baked food, resulting in not only a poor release but also an undesirable greasiness in texture and taste.

The solid stick pan lubricant disclosed in U.S. Pat. No. 4,023,912 may provide uneven distribution of lubricant material. The solid stick pan lubricant relies on the dexterity of the consumer in providing the proper amount of hand pressure for applying the lubricant material. Providing an improper amount of hand pressure presents the possibility of inadequate lubricant quantity and coverage, perhaps resulting in clumping or stick-breakage. Therefore, there exists a need for systems and methods for addressing these and/or other problems associated with lubricating a baking vessel and/or its contents.

### SUMMARY OF THE INVENTION

The present invention provides systems and methods for placing a lubricating layer at the bottom of a baking vessel. In one embodiment of the invention, a baking wipe includes a folded substrate having a first portion and a second portion, wherein a first surface of the first portion faces a second surface of the second portion, and a layer of shortening that is located between the first portion and the second portion, and that is in contact with the first surface and with the second surface, wherein the layer of shortening has a substantially uniform thickness.

Other embodiments of the present invention will become apparent to one with ordinary skill in the art upon examination of the following drawings and detailed description.

### BRIEF DESCRIPTION OF THE DRAWINGS

FIGS. 1A and 1B are schematic diagrams illustrating a top view and a side view, respectively, of an embodiment of a folded baking wipe according to the present invention.

FIGS. 2A and 2B are schematic diagrams illustrating a top view and a side view, respectively, of an embodiment of an unfolded baking wipe that may be formed by unfolding the folded baking wipe illustrated in FIGS. 1A and 1B.

FIGS. 3A and 3B are schematic diagrams illustrating a top view and a side view, respectively, of an embodiment of a folded baking wipe according to the present invention.

FIGS. 4A and 4B are schematic diagrams illustrating a top view and a side view, respectively, of an embodiment of an unfolded baking wipe that may be formed by unfolding the folded baking wipe illustrated in FIGS. 3A and 3B.

FIGS. 5A and 5B are schematic diagrams illustrating a top view and a side view, respectively, of an embodiment of a folded baking wipe according to the present invention.

FIGS. 6A, 6B, and 6C are schematic diagrams illustrating a top view, a side view, and a bottom view respectively, of an embodiment of an unfolded baking wipe that may be formed by unfolding the folded baking wipe illustrated in FIGS. 5A and 5B.

FIG. 7 is a schematic diagram illustrating a perspective view of an embodiment of a baking wipe assembly according to the invention.

FIGS. 8A and 8B are schematic diagrams depicting a top view and a front view, respectively, of an unopened baking wipe dispensing system.

FIGS. 8C and 8D are schematic diagrams depicting a top view and a front view, respectively, of an opened baking wipe dispensing system.

FIG. 9 is a flow chart illustrating an embodiment of a method for manufacturing a folded baking wipe according to the present invention.

FIG. 10 is a flow chart illustrating an embodiment of a method for manufacturing a plurality of folded baking wipes according to the present invention.

FIG. 11 is a flow chart illustrating an embodiment of a method for forming a baking wipe assembly according to the present invention.

FIG. 12 is a flow chart illustrating an embodiment of a method for manufacturing a plurality of baking wipe assemblies according to the present invention.

FIG. 13A is a flow chart illustrating a method for using a baking wipe according to the present invention.

FIG. 13B is a flow chart illustrating a method for using a baking wipe assembly according to the present invention.

### DETAILED DESCRIPTION OF THE PREFERRED EMBODIMENTS

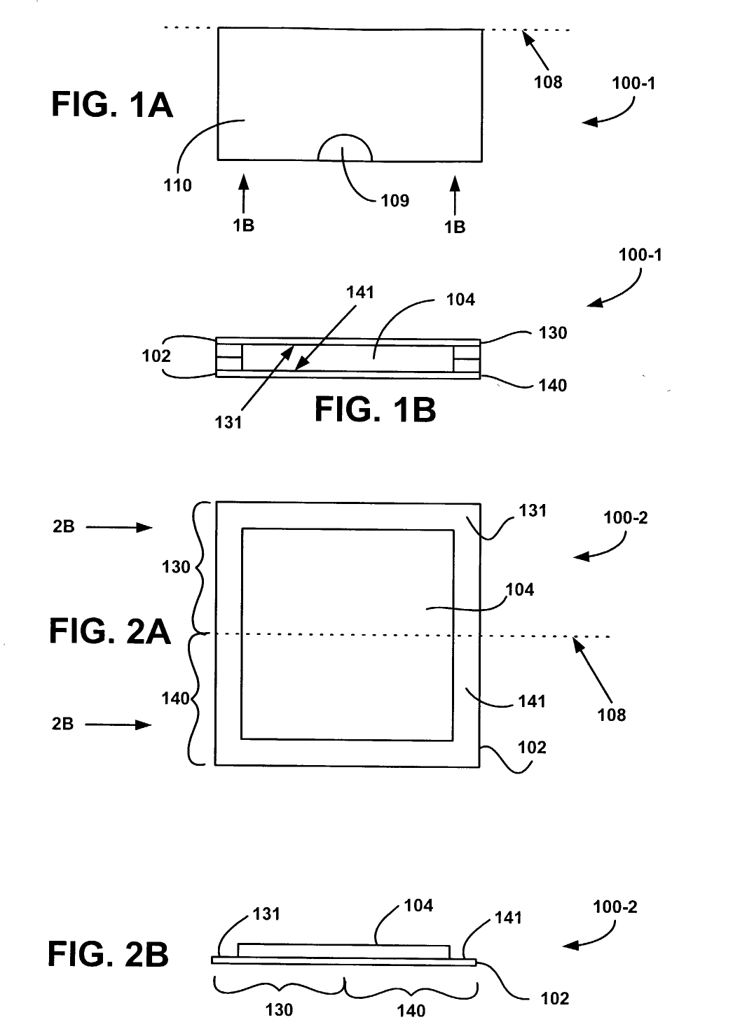

FIGS. 1A and 1B are schematic diagrams illustrating a top view and a side view, respectively, of an embodiment of a folded baking wipe 100-1 according to the present invention. The folded baking wipe 100-1 includes a substrate 102 having a first portion 130 (e.g., a first half) and a second portion 140 (e.g., a second half) that are connected to each other near an axis 108. The substrate 102 may comprise a type of paper such as, for example, dry wax paper or wax paper (i.e., wax-coated paper), among others. The first portion 130 has a first surface 131, and the second portion 140 has a second surface 141. The folded baking wipe 100-1 also includes a layer of shortening 104 (e.g., vegetable shortening) that is located between the first portion 130 and the second portion 140, and that is in contact with the first surface 131 and with the second surface 141. As used herein, the term “shortening” refers to any fat or combination of fats than can be used in a baking process, including animal and/or vegetable fats. In a preferred embodiment, the layer of shortening 104 comprises partially hydrogenated vegetable oil (e.g., partially hydrogenated soybean and/or cottonseed oils). The layer of shortening 104 preferably has a substantially uniform thickness and solidity or firmness. The folded baking wipe 100-1 may be packaged in a container, side-by-side with the folded-edge facing upwards, along with other baking wipes without the layer of shortening 104 coming into contact with the other baking wipes. Furthermore, Outer portions of the first surface 131 and the second surface 141 may be not coated with shortening so that the folded baking wipe 100-1 may be easily and cleanly unfolded and used by a user without the layer of shortening 104 coming into contact with the user's hands. A portion 109 of the outer surface 110 of the folded baking wipe 100-1 may have a distinguishing color (e.g., red) to indicate the location where the folded baking wipe 100-1 may be grasped and pulled in order to be unfolded.

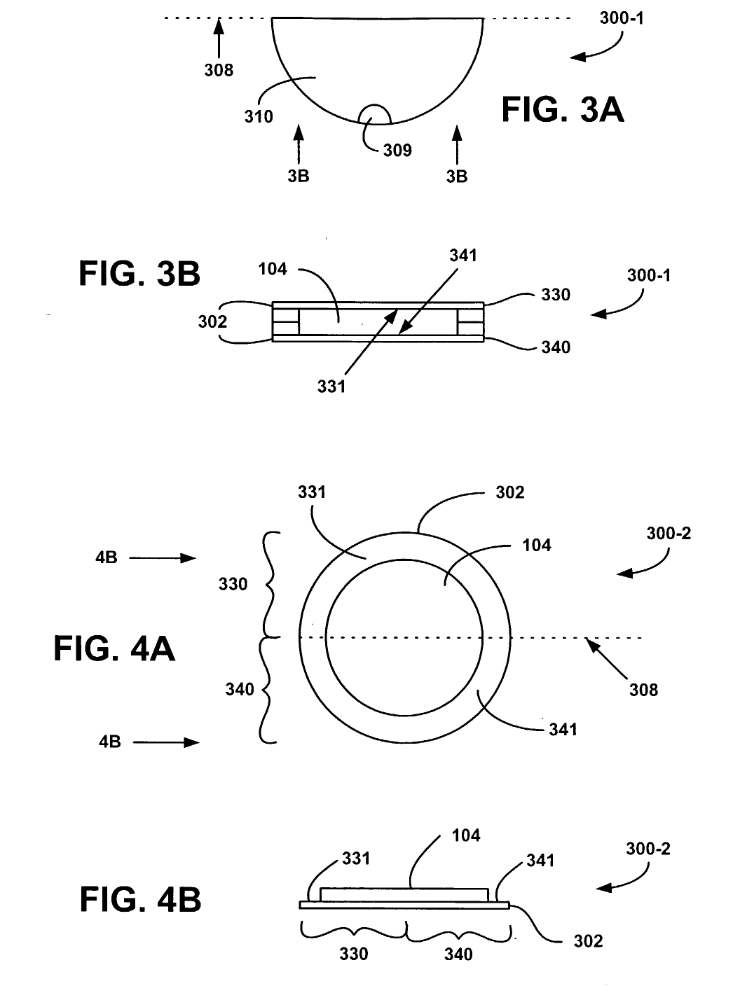

FIGS. 2A and 2B are schematic diagrams illustrating a top view and a side view, respectively, of an embodiment of an unfolded baking wipe 100-2 according to the invention. The unfolded baking wipe 100-2 comprises a layer of shortening 104 that covers at least a portion of the first surface 131 and the second surface 141. The unfolded baking wipe 100-2 may be formed by unfolding the folded baking wipe 100-1 (FIGS. 1A and 1B), and may be used to coat a baking vessel (e.g., a pan) with shortening by wiping the baking vessel with the layer of shortening 104.

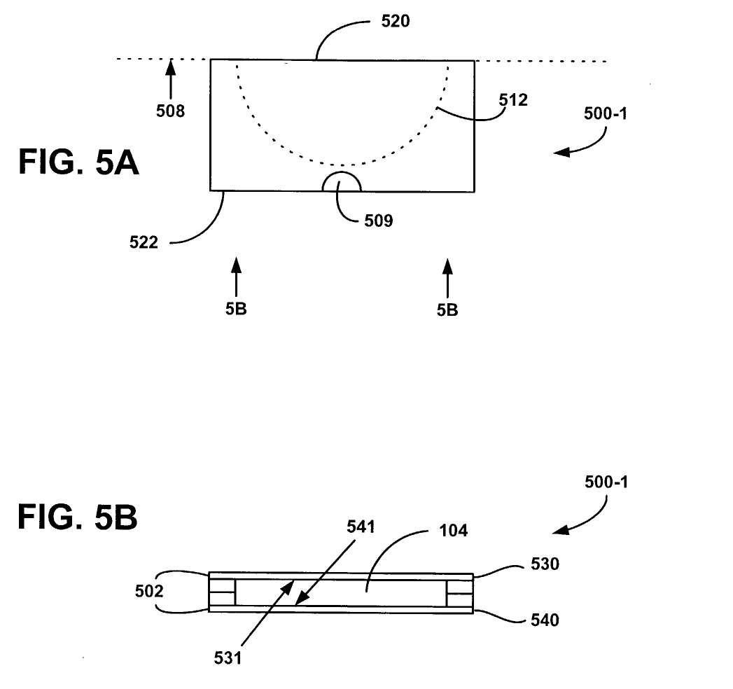

FIGS. 3A and 3B are schematic diagrams illustrating a top view and a side view, respectively, of an embodiment of a folded baking wipe 300-1 according to the present invention. The folded baking wipe 300-1 represents an alternative embodiment to the folded baking wipe 100-1 (FIG. 1). The folded baking wipe 300-1 includes a substrate 302 having a first portion 330 (e.g., a first half) and a second portion 340 (e.g., a second half) that are connected to each other near an axis 308. The substrate 302 may comprise a type of paper such as, for example, dry wax paper or wax paper, among others. The first portion 330 has a first surface 331, and the second portion 340 has a second surface 341. The folded baking wipe 300-1 also includes a layer of shortening 104 that is located between the first portion 330 and the second portion 340, and that is in contact with the first surface 331 and with the second surface 341. The layer of shortening 104 preferably has a substantially uniform thickness. Outer portions of the first surface 331 and the second surface 341 may be not coated with shortening so that the folded baking wipe 300-1 may be easily and cleanly unfolded and used by a user without the layer of shortening 104 coming into contact with the user's hands. A portion 309 of the outer surface 310 of the folded baking wipe 300-1 may have a distinguishing color (e.g., red) to indicate the location where the folded baking wipe 300-1 may be grasped and pulled in order to be unfolded.

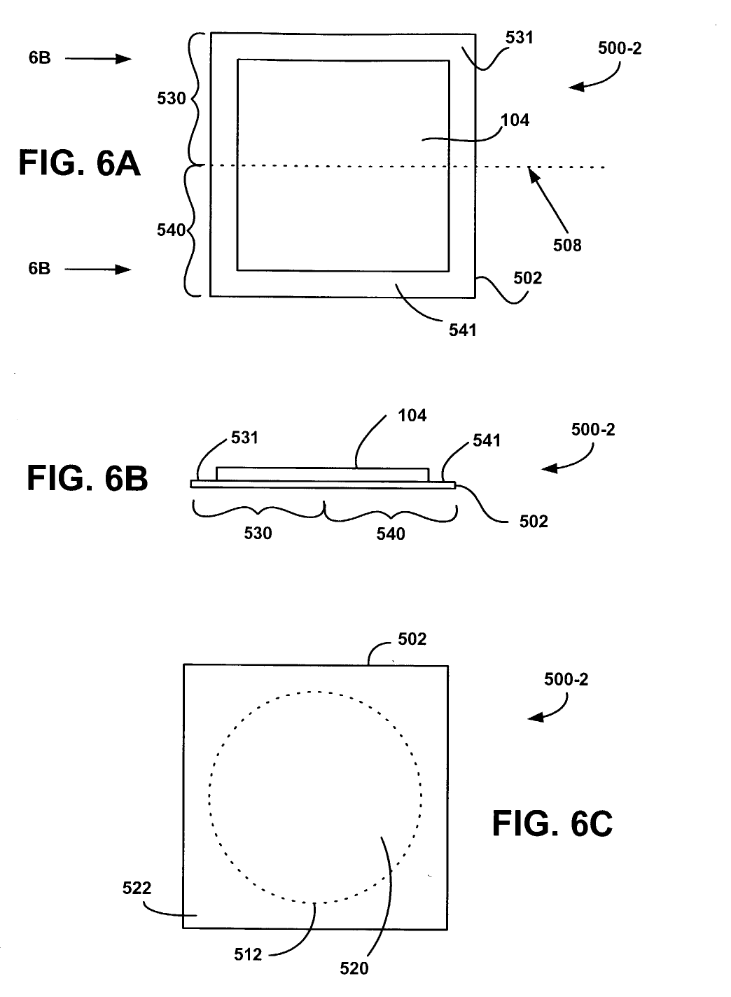

FIGS. 4A and 4B are schematic diagrams illustrating a top view and a side view, respectively, of an embodiment of an unfolded baking wipe 300-2 according to the invention. The unfolded baking wipe 300-2 comprises a substantially circular substrate 302 and a layer of shortening 104 that covers at least a portion of the first surface 331 and the second surface 341. The unfolded baking wipe 300-2 may be formed by unfolding the folded baking wipe 300-1 (FIGS. 3A and 3B), and may be used to coat a baking vessel with shortening by wiping the baking vessel with the layer of shortening 104. The baking wipe 300-2 may also be placed at the bottom of a baking vessel with the layer of shortening facing up. This may be done, for example, when a recipe requires that a sheet of wax paper coated with shortening be placed at the bottom of a baking vessel.

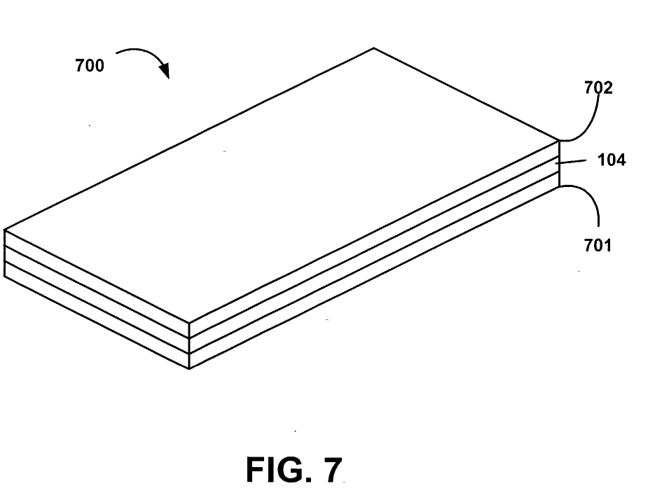

FIGS. 5A and 5B are schematic diagrams illustrating a top view and a side view, respectively, of an embodiment of a folded baking wipe 500-1 according to the present invention. The folded baking wipe 500-1 represents an alternative embodiment to the folded baking wipe 100-1 (FIG. 1). The folded baking wipe 500-1 includes a substrate 502 having a first portion 530 (e.g., a first half) and a second portion 540 (e.g., a second half) that are connected to each other near an axis 508. The substrate 502 may comprise a type of paper such as, for example, dry wax paper or wax paper, among others. The first portion 530 has a first surface 531, and the second portion 540 has a second surface 541. The folded baking wipe 500-1 also includes a layer of shortening 104 that is located between the first portion 530 and the second portion 540, and that is in contact with the first surface 531 and with the second surface 541. The layer of shortening 104 preferably has a substantially uniform thickness. The baking wipe 500-1 includes perforations 512 that enable a portion 520 to be separated from the remainder 522 of the folded baking wipe 500-1. The portion 520 may then be unfolded into a substantially circular baking wipe and placed at the bottom of a substantially circular baking vessel. Outer portions of the first surface 531 and the second surface 541 may be not coated with shortening so that the folded baking wipe 500-1 may be easily and cleanly unfolded and used by a user without the layer of shortening 104 coming into contact with the user's hands. A portion 509 of the outer surface of the folded baking wipe 500-1 may have a distinguishing color (e.g., red) to indicate the location where the folded baking wipe 500-1 may be grasped and pulled in order to be unfolded.

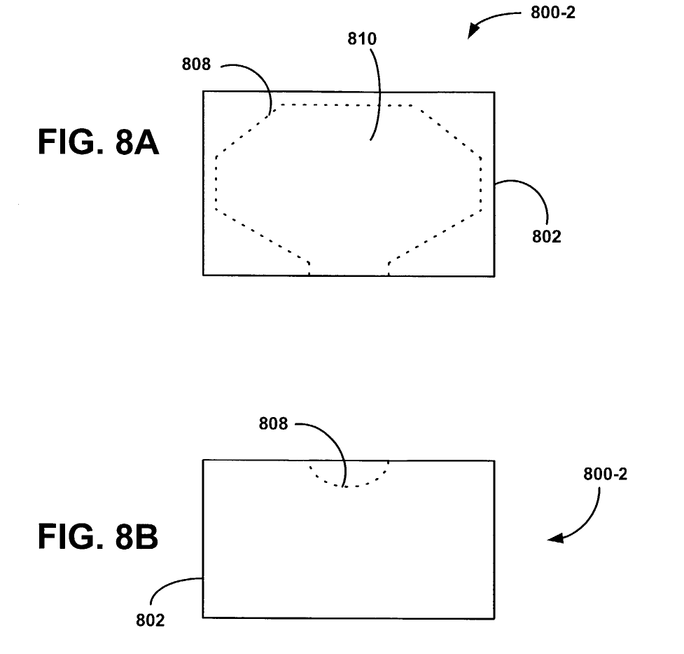

FIGS. 6A, 6B, and 6C are schematic diagrams illustrating a top view, a side view, and a bottom view respectively, of an embodiment of an unfolded baking wipe 500-2 according to the invention. The unfolded baking wipe 500-2 comprises a substrate 502 and a layer of shortening 104 that covers at least a portion of the first surface 531 and the second surface 541. The unfolded baking wipe 500-2 may be formed by unfolding the folded baking wipe 500-1 (FIGS. 5A and 5B), and may be used to coat a baking vessel (e.g., a pan) with shortening by wiping the baking vessel with the layer of shortening 104. Alternatively, the unfolded baking wipe 500-2, or a portion thereof (e.g., portion 520), may be positioned at the bottom of a compatibly sized baking vessel (e.g., having an 8″ or 9″ diameter) such that the layer of shortening 104, or a portion thereof, is facing upward.

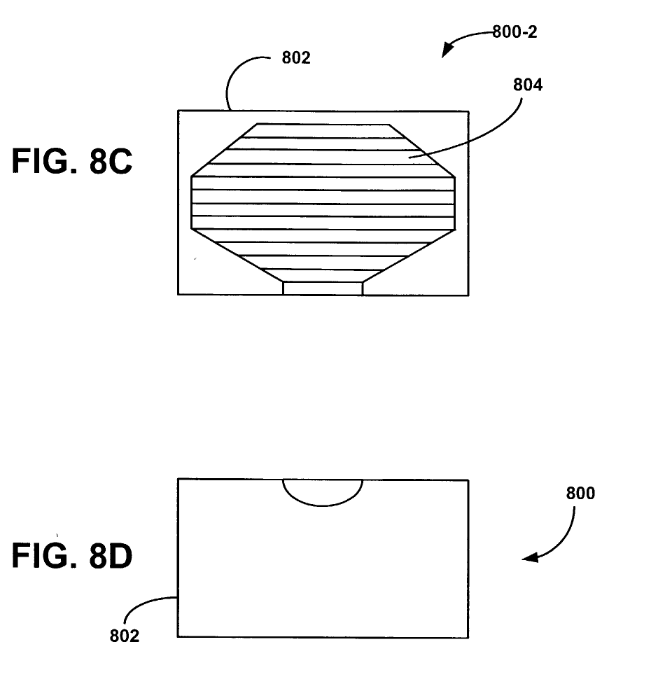

FIG. 7 is a schematic diagram illustrating a perspective view of an embodiment of a baking wipe assembly 700 according to the invention. The baking wipe assembly 700 comprises a first substrate 701, a second substrate 702, and a layer of shortening 104 that is located between the two substrates 701 and 702. In one embodiment, the first substrate 701 comprises dry wax paper, whereas the second substrate 702 comprises wax paper. The layer of shortening 104 preferably has a substantially uniform thickness.

The first substrate 701 and the second substrate 702 may be pulled apart, thereby resulting in the first substrate 701 and/or the second substrate 702 having shortening attached thereto, depending on a desired implementation (i.e., depending on the relative composition of the substrates 701 and 702). If the substrates 701 and 702 have substantially the same affinity to shortening (e.g., if both comprise wax paper), then roughly equal amounts of shortening will remain on the substrates when they are pulled apart, and either or both substrates may be used to grease a baking vessel. However, if the substrates 701 and 702 have different affinity to shortening (e.g., if substrate 701 comprises dry wax paper and substrate 702 comprises wax paper), then one substrate (e.g., substrate 701) may have substantially all of the shortening 104 attached to it when the substrates 701 and 702 are pulled apart; the other substrate (e.g., substrate 702) may have a negligible amount of shortening remaining thereon. The substrate having the most shortening attached thereto may then be used to grease a baking vessel or may be placed on the bottom of the baking vessel, and the other substrate may simply be discarded.

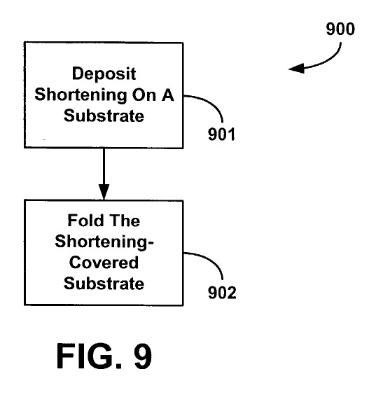

FIGS. 8A and 8B are schematic diagrams depicting a top view and a front view, respectively, of an unopened baking wipe dispensing system (UBWDS) 800-1. The UBWDS 800-1 includes a container 802 and a plurality of baking wipes (not shown) that are located within the container 802. Each of the baking wipes may be, for example, one of the folded baking wipes illustrated in FIGS. 1-7, and may be placed side-by-side in the container 802, with the folded edge facing upward. The container 802 may include perforations 808 that enable a portion 810 of the container to be removed so that one or more of the baking wipes inside the container 802 may be exposed and the baking wipe may be easily and cleanly removed from the container.

FIGS. 8C and 8D are schematic diagrams depicting a top view and a front view, respectively, of an opened baking wipe dispensing system (OBWDS) 800-2. The OBWDS 800-2 may be formed by separating the portion 810 (FIG. 8A) from the remainder of the container 802. The OBWDS includes a plurality of baking wipes 804 that are located within the container 802. Each of the baking wipes 804 may be easily grasped and removed from the container 802 and then used to grease or line the bottom of a baking vessel.

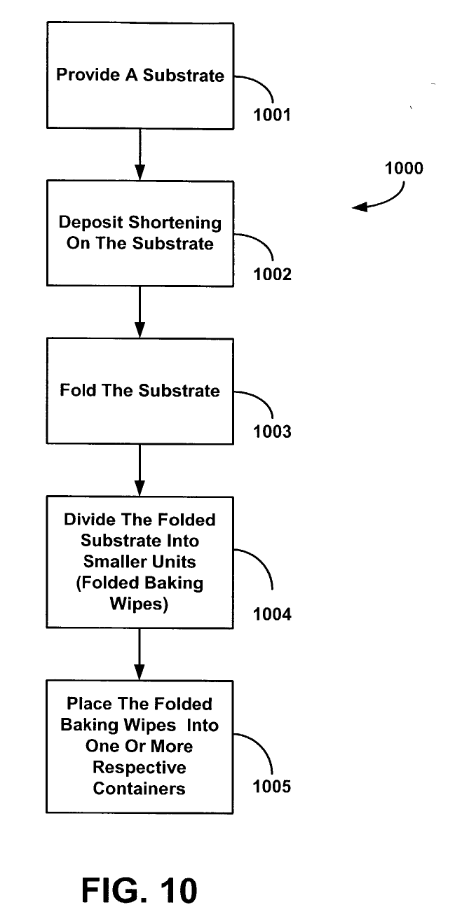

FIG. 9 is a flow chart illustrating an embodiment of a method 900 for manufacturing a folded baking wipe according to the present invention. The method 900 includes depositing shortening on a substrate (step 901) and then folding the shortening-covered substrate (step 902) to form a folded baking wipe. The substrate may comprise a type of paper such as, for example, dry wax paper or wax paper, among others. A uniform layer of shortening is preferably applied to the substrate in step 901. Furthermore, the shortening covered substrate is preferably folded substantially “in half” in step 902 such that the shortening is located between substantially equal portions of the substrate.

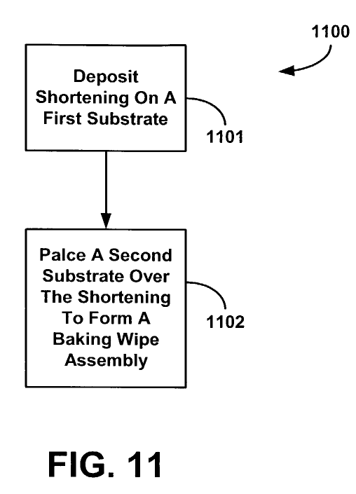

FIG. 10 is a flow chart illustrating an embodiment of a method 1000 for manufacturing a plurality of folded baking wipes according to the present invention. The method 1000 includes providing a substrate (step 1001) and depositing shortening on the substrate (step 1002). The substrate may comprise a type of paper (e.g., dry wax paper or wax paper, among others) that is several (e.g., 12″) inches wide and several feet long. The shortening-covered substrate is then folded (step 1003), and then divided into smaller units (folded baking wipes) (step 1004). The folded baking wipes may then be placed into one or more respective containers (step 1005). Each of the folded baking wipes may be, for example, 12″ long and 6″ wide, but may then become a 12″ long and 12″ wide baking wipe after it is unfolded.

In one embodiment, between steps 1001 and 1002, the substrate may be perforated along circular or curved paths that outline portions (e.g., circular portions) that may later be removed and used by a consumer, for example, as discussed above in reference to FIG. 5A. Furthermore, if liquefied shortening is deposited in step 1002, the liquefied shortening may be cooled until it becomes semi-solid (e.g., at room temperature), prior to the shortening-covered substrate being folded in step 1003.

The following is a non-limiting example of a specific implementation, among others, of the method 1000. An industrial supply paper roll (e.g., that is 12″ wide and hundreds of feet long) is placed on a metal spindle. The paper may be, for example, dry wax paper or wax paper. The paper proceeds off the roll through a series of tension bars to keep the paper taught. In one embodiment for manufacturing perforated baking wipes, the paper is perforated at approximately 5 to 10 feet from the paper roll, where the paper passes under a 9″ diameter round die cut that forms perforations in the paper. At approximately 10 to 15 feet from the paper roll, the paper passes under a small diameter, food-grade nozzles connected to a stainless steel heated vessel. The vessel contains an edible fatty composition of partially hydrogenated soybean and cottonseed oils with mono and di-glycerides. The vessel may be heated and agitated to maintain the fatty composition in liquid form. Under pressure, through the nozzles, the paper receives a fine and uniform spraying of the liquid composition. After being coated with the edible fatty composition, the paper proceeds approximately 5 to 10 feet further until the paper passes under a series of cold-air guns, where the shortening may be cooled to approximately room temperature. The paper then proceeds through guide bars approximately 5 to 10 feet further, at which point the guide bars fold the paper widthwise, with the edible fatty composition remaining between the folded sides of the paper. The width of the folded paper is preferably 6″. The folded paper proceeds another 5 to 10 feet further, at which point it is cut lengthwise at predetermined intervals (e.g., at 12″ intervals) to form folded baking wipes. The folded baking wipes are then placed in respective containers. Each container may accommodate, for example, between 15 to 20 baking wipes.

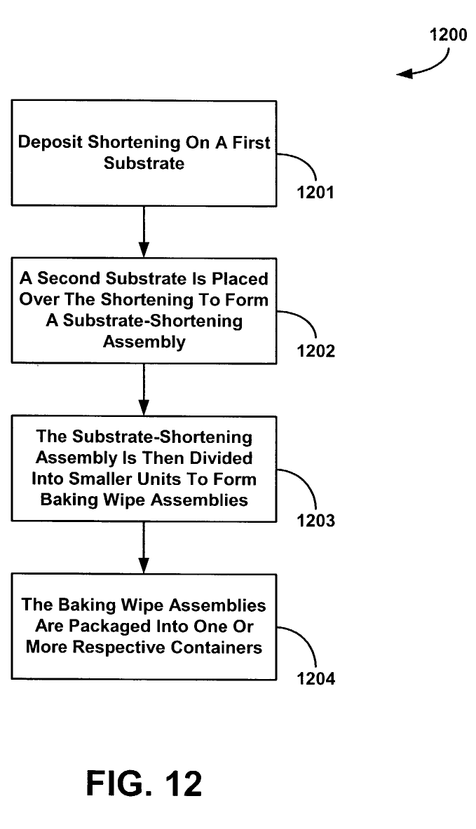

FIG. 11 is a flow chart illustrating an embodiment of a method 1100 for forming a baking wipe assembly according to the present invention. The method 1100 includes depositing shortening on a first substrate of dry wax or non-coated paper or wax paper (step 1101) and then placing a second substrate of non-absorbent wax paper over the shortening (step 1102) to form the baking wipe assembly. A uniform layer of shortening is preferably applied to the first substrate in step 1101. The first substrate and the second substrate may each comprise, for example, dry wax paper or wax paper. Furthermore, the first substrate and the second substrate preferably have about the same surface area.

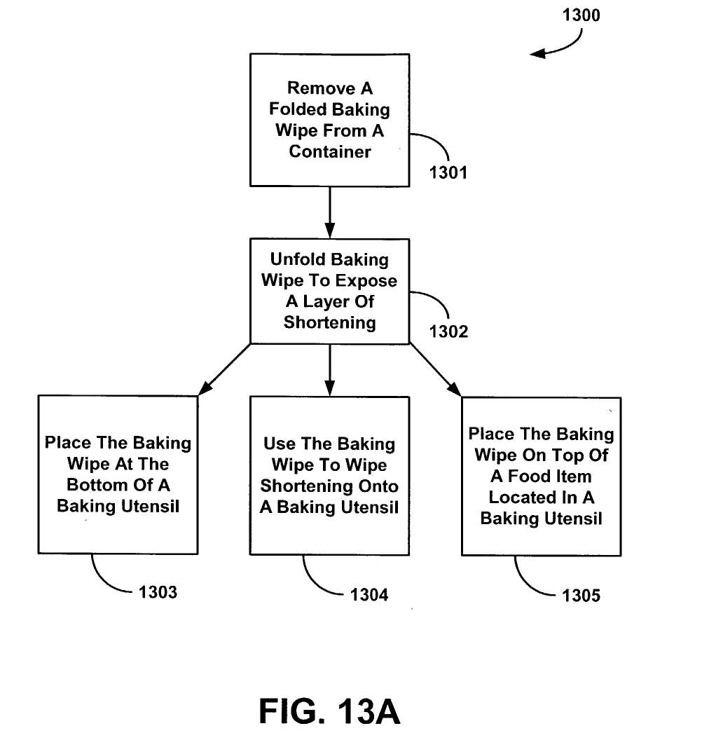

FIG. 12 is a flow chart illustrating an embodiment of a method 1200 for manufacturing a plurality of baking wipe assemblies according to the present invention. The method 1210 includes depositing shortening on a first substrate (step 1201). The first substrate may proceed from a master roll that measures, for example, several (e.g., 12) inches wide and that is several feet long (when unrolled).

After depositing a suitable and uniform amount of shortening on the first substrate, a second substrate is placed over the shortening to form a substrate-shortening assembly (step 1202). The second substrate preferably, which may comprise, for example, non-absorbent wax paper, has the same length and width as the first substrate. The substrate-shortening assembly is then divided into smaller units to form baking wipe assemblies (step 1203). Each of the baking wipe assemblies may be, for example, similar to the baking wipe assembly 700 illustrated in FIG. 7. The baking wipe assemblies may then be packaged (e.g., by stacking one on top of the other) into one or more respective containers (step 1204). In one embodiment, where liquefied shortening is deposited in step 1201, the liquefied shortening may be cooled until it becomes semi-solid (e.g., at room temperature) prior to the second substrate being placed over the shortening in step 1202.

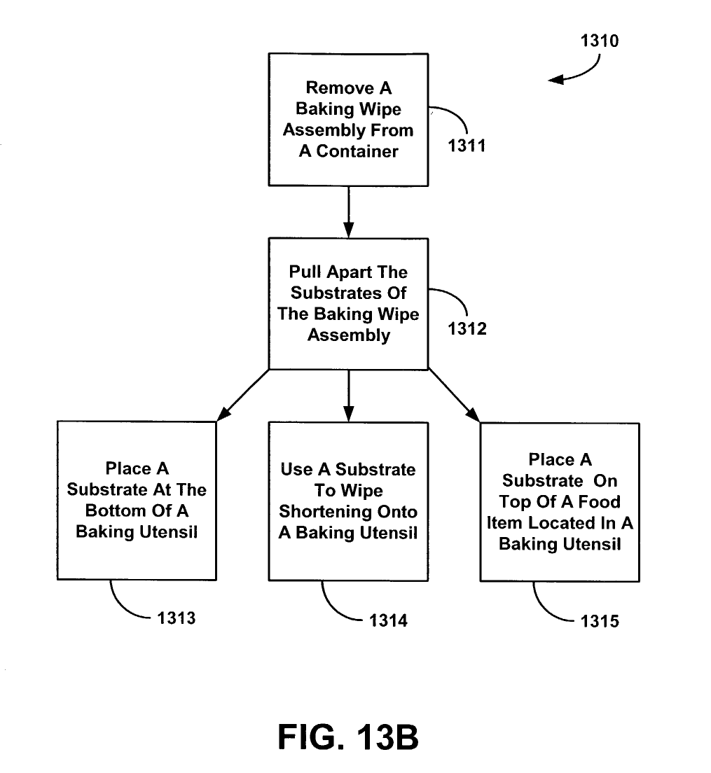

FIG. 13A is a flow chart illustrating a method 1300 for using a baking wipe according to the present invention. As illustrated in FIG. 13A, a folded baking wipe is removed from a container (step 1301) and is unfolded (e.g., by grasping and pulling at a designated location) to expose a layer of shortening (step 1302). Then the unfolded baking wipe may be used in one of three ways: it may be placed at the bottom of a baking vessel (step 1303) with its layer of shortening facing up; it may be applied by hand to wipe shortening onto the baking vessel (step 1104); or it may be placed on top of a food item located in the baking vessel (step 1305), with its layer of shortening in contact with the top surface of the food item.

FIG. 13B is a flow chart illustrating a method 1310 for using a baking wipe assembly according to the present invention. As illustrated in FIG. 13A, a baking wipe assembly is removed from a container (step 1311) and is pulled apart to form two separate substrates, at least one of which is coated with shortening (step 1312). The shortening coated substrate(s) may then be used in one of three ways: it may be placed at the bottom of a baking vessel with its layer of shortening facing up (step 1313); it may be used to wipe shortening onto the baking vessel (step 1314); or it may be placed on top of a food item located in the baking vessel (step 1315), with its layer of shortening in contact with the top surface of the food item.

It should be emphasized that the above-described embodiments of the present invention are merely possible examples, among others, of some of the methods, systems and implementations of the present invention, and are intended to provide a clear understanding of the principles of the invention. Many variations and modifications may be made to the above-described embodiments of the invention without departing significantly or notably from the principles of the invention. For example, any substrate discussed above (including substrates 102, 302, 502, 701, and 702) may alternatively comprise any suitable material or combination of materials (e.g., paper, wax, plastic, and/or metal, among others), including a material or combinations of materials now known or later developed. All modifications and variations that do not depart significantly or notably from the principles of the invention are intended to be included herein within the scope of the disclosure and present invention, and to be protected by the following claims.

What is claimed is:

1. A baking wipe comprising:
a folded substrate having a first portion and a second portion, wherein a first surface of the first portion faces a second surface of the second portion; and
a layer of shortening that is located between the first portion and the second portion, and that is in contact with the first surface and with the second surface, wherein the layer of shortening has a substantially uniform thickness.

2. The baking wipe of claim 1, wherein the shortening comprises partially hydrogenated vegetable oil.

3. The baking wipe of claim 1, wherein the shortening comprises animal fat.

4. A container comprising a plurality of baking wipes that are each configured in an essentially same manner as the baking wipe of claim 1.

5. The baking wipe of claim 1, wherein the baking wipe is perforated along a curved path such that a folded portion of the baking wipe may be easily detached from the baking wipe along the curved path.

6. The baking wipe of claim 1, wherein the folded substrate comprises dry wax paper.

7. The baking wipe of claim 1, wherein the folded substrate comprises wax paper.

8. A baking wipe comprising:
a first substrate;
a second substrate
a layer of shortening that is located between the first substrate and the second substrate and that is in contact with the first substrate and with the second substrate.

9. The baking wipe of claim 8, wherein the shortening comprises partially hydrogenated vegetable oil.

10. The baking wipe of claim 8, wherein the shortening comprises animal fat.

11. A container comprising a plurality of baking wipes that are each configured in an essentially same manner as the baking wipe of claim 8.

12. The baking wipe of claim 8, wherein the first substrate comprises dry wax paper or wax paper and the second substrate comprises dry wax paper or wax paper.

13. The baking wipe of claim 8, wherein the first substrate comprises dry wax paper, and the second substrate comprises wax paper.

14. A method for manufacturing a baking wipe comprising:
depositing shortening on a substrate having a first portion and a second portion; and
folding the substrate such that a first surface of the first portion faces a second surface of the second portion, such that the shortening is located between the first portion and the second portion and is in contact with the first surface and with the second surface.

15. The method of claim 14, wherein the step of depositing the shortening comprises depositing a substantially uniform layer of the shortening on the substrate.

16. The method of claim 14, wherein a substantially uniform layer of the shortening is located between the first portion and the second portion after the substrate is folded.

17. The method of claim 14, further comprising:
perforating the substrate along a curved path.

18. The method of claim 14 further comprising:
Placing the baking wipe and a plurality of other baking wipes in a container.

19. A method for manufacturing a baking wipe comprising:
depositing shortening on a first substrate; and
placing a second substrate over the shortening such that the shortening is located between the first substrate and the second substrate, and is in contact with the first substrate and with the second substrate.

20. The method of claim 19, further comprising:
Placing the baking wipe in a container.
